(19) United States
(12) Patent Application Publication
(10) Pub. No.: US 2006/0283074 A1
(43) Pub. Date: Dec. 21, 2006

(54) Fishing float

(76) Inventors: Tom Barrow, Newmarket (CA); Don Gervais, Newmarket (CA); Phillip Beaudet, Stouffville (CA)

Correspondence Address: GEORGE A. ROLSTON, 45 SHEPPARD AVE EAST, SUITE 900, TORONTO, ON, M2N5W9, CA

(21) Appl. No.: 11/365,594

(22) Filed: Mar. 2, 2006

Related U.S. Application Data
(60) Provisional application No. 60/657,428, filed on Mar. 2, 2005.

(51) Int. Cl. A01K 93/00

(52) U.S. Cl. 43/44.87

(57) ABSTRACT

A float for a fishing line consisting of an elongate member having a first end and a second end, at least two floatation members coupled to the elongate member, and an engagement portion coupled to the first end of the elongate member and dimensioned to engage with a stop means provided on the fishing line. The float is positionable between a disengaged position and an engaged position, wherein the elongate member is positioned generally vertically in the engaged position, and wherein in the elongate member is positioned generally horizontally in the disengaged position.

### PRIOR APPLICATION

This application claims the benefit of U.S. Provisional Application Ser. No. 60/657,428, filed Mar. 2, 2005, entitled FISHING FLOAT.

### FIELD OF THE INVENTION

The invention relates to a fishing float, and more particularly to an adjustable depth fishing float for indicating the presence of a fish on a fishing line.

### BACKGROUND OF THE INVENTION

Using a common fishing technique, an angler suspends a baited hook from a fishing float on a fishing line into a water body, such as a river or lake. Ideally, the angler suspends the baited hook from the fishing float in close proximity to the bottom surface of the water body so as to allow the baited hook to drift naturally at the same speed as the water current. As the angler becomes more proficient with the use of fishing floats, they may become adept at casting the baited hook and fishing float into natural breaks in the current and at positioning the float adjacent to pools and eddies in the water body. However, the ability of both amateur and proficient anglers to identify when a fish has taken or attacked the baited hook can be increasingly difficult in extreme conditions, such as in turbulent, icy or debris-laden rivers, or when fishing for passive or highly sensitive fish.

This difficulty is addressed to some extent by pivotal fishing floats consisting of a pivot member that causes a small luminous stick to project above the surface of the water body when the baited hook is attacked by a fish. Since the fishing line used with pivotal fishing floats are commonly bisected at the hinge member, such that separate fishing lines extend between the fishing rod and the float, and then between the float and the baited hook, it is difficult to adjust the depth at which the bait hook will suspend between the fishing float. Additionally, due to the non-buoyant nature of most luminous sticks, under the slightest attack of a fish, the small fluorescent stick of the pivotal fishing float will be pulled under the surface of the water body and be difficult for the angler to observe. Moreover, the pivot member often jams or freezes in icy conditions, resulting in the angler being unaware of the presence of a fish on the baited hook.

Other types of fishing floats consist of a narrow tubular member through which a continuous length of fishing line extends from the fishing rod to the baited hook. This tubular member is often then connected to the fishing float via a hinge member which is adapted to cause the luminous stick to project above the water surface. In addition to the frequent freezing of the hinge member, the narrow tubular member can become clogged by the intrusion of debris and ice, thereby causing the pulling on the fishing line and false indications of the presence of a fish. Since the clogging of the tubular member can be difficult to clear, the angler may not be able to adapt to different fishing conditions by changing the desired fishing depth.

Accordingly, there is a need for an improved fishing float which enables the angler to observe when a fish has taken or attacked a baited hook. There is also a need for an improved fishing float which minimizes the need for the angler to unnecessary clear debris and frozen particles from the float. There is a further need for a fishing float which receives a single length of fishing line and which facilitates the easy adjustment of the depth at which the baited hook suspends below the fishing float.

### SUMMARY OF THE INVENTION

The subject invention is directed to a float for a fishing line. The fishing float comprises an elongate member having a first end and a second end, at least two floatation members coupled to the elongate member, and an engagement portion coupled to the first end of the elongate member, the engagement portion being dimensioned to engage with a stop means provided on the fishing line. The fishing float is positionable between an engaged position and a disengaged position, wherein the elongate member is positioned generally vertically in the engaged position, and wherein in the elongate member is positioned generally horizontally in the disengaged position.

The elongate member moves into the engaged position as the stop means engages with the engagement means. The engagement portion is formed with an aperture for receiving the fishing line, and wherein the dimension of the aperture is smaller than the dimension of the stop means. The location of the stop means is adjustable along the fishing line, whereby the location of the stop means corresponds to a pre-determined depth of the fishing hook. The stop means may also include a limiter adapted to maintain the fishing hook substantially at the pre-determined fishing depth.

The at least two floatation members include a first floatation member and a second floatation member, wherein the first floatation member is positioned generally proximate to the first end of the elongate member, and wherein the second floatation member is positioned generally proximate to the second end of the elongate member. The at least two flotation members may be formed of a sufficiently buoyant material, such as a lightweight plastic or cork material. The at least two floatation members may also be coated in a luminescent material. The at least two floatation members and the elongated member may be integrally formed.

The subject invention is also directed to a float for adjustably locating a fishing hook at a pre-determined depth, comprising an elongate member having a first end and a second end, at least two floatation members coupled to the elongate member, the float members being sufficiently buoyant to maintain the fishing float afloat, and an engagement portion coupled to the first end of the elongate member, the engagement portion being dimensioned to receive and engage with a stop means providing on a fishing line, whereby the location of the stop means along the fishing line corresponds to a pre-determined depth of the fishing hook. The fishing float is positionable between an engaged position and a disengaged position as the fishing hook substantially maintains the pre-determined depth. In the engaged position, the elongate member is positioned generally vertically, and in the disengaged position the elongate member is positioned generally horizontally.

The subject invention is also directed to a float for a fishing line having a fishing hook, comprising an elongate member having a first end and a second end, a first floatation member, the first floatation member being coupled to the elongate member generally proximate to the first end, a second floatation member, the second floatation member being coupled to the elongate member generally proximate to the second end, an engagement portion coupled to the first end of the elongate member, and a stop means provided on the fishing line, whereby the generally downward movement of the fishing line causes the stop means to engage with the engagement portion and the elongate member to move from an engaged position to a disengaged position. The elongate member is positioned generally vertically in the engaged position, and the elongate member is positioned generally horizontally in the disengaged position. The second floatation member is positioned generally above the first floatation member when the elongate member is positioned in the engaged position.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a perspective view of a float made in accordance with a preferred embodiment of the invention, shown receiving a fishing line;

FIG. 2 is a side elevation view of the float of FIG. 1 shown in a disengaged position;

FIG. 3 is a side elevation view of the float of FIG. 1 shown in an engaged position; and

FIG. 4 is side elevation view of the float where the elongate member and the at least two floatation members are integrally formed.

### DETAILED DESCRIPTION OF THE INVENTION

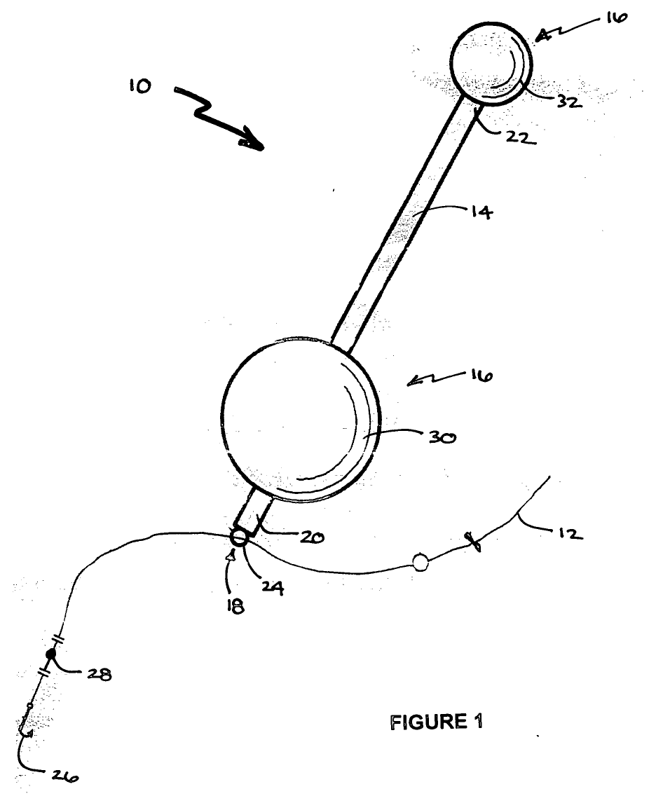

Reference is made to FIGS. 1-3 which illustrate a fishing float 10 provided on a fishing line 12 in accordance with a preferred embodiment of the present invention for fishing in various water bodies. Float 10 comprises an elongate member 14, one or more floatation members 16, and an engagement portion 18 coupled to the elongate member 14. The elongate member 14 has a first end 20 and a second end 22. The engagement portion 18 is coupled to and extends from the first end 20 of the elongate member 14, and includes a loop or eyelet 24 through which an angler may thread the fishing line 12. The fishing line 12 may be provided with a fishing hook 26 and a sinker 28.

In the embodiment of the present invention shown in FIGS. 1-3, the one or more floatation members 16 include a first floatation member 30 and a second floatation member 32. The first floatation member 30 is positioned on the elongate member 14 generally proximate to the first end 20, while the second floatation member 32 is positioned generally proximate to the second end 22. The first and second floatation members 30 and 32 are substantially circular in shape, with the first floatation member 30 having a generally larger diameter than the second floatation member 32.

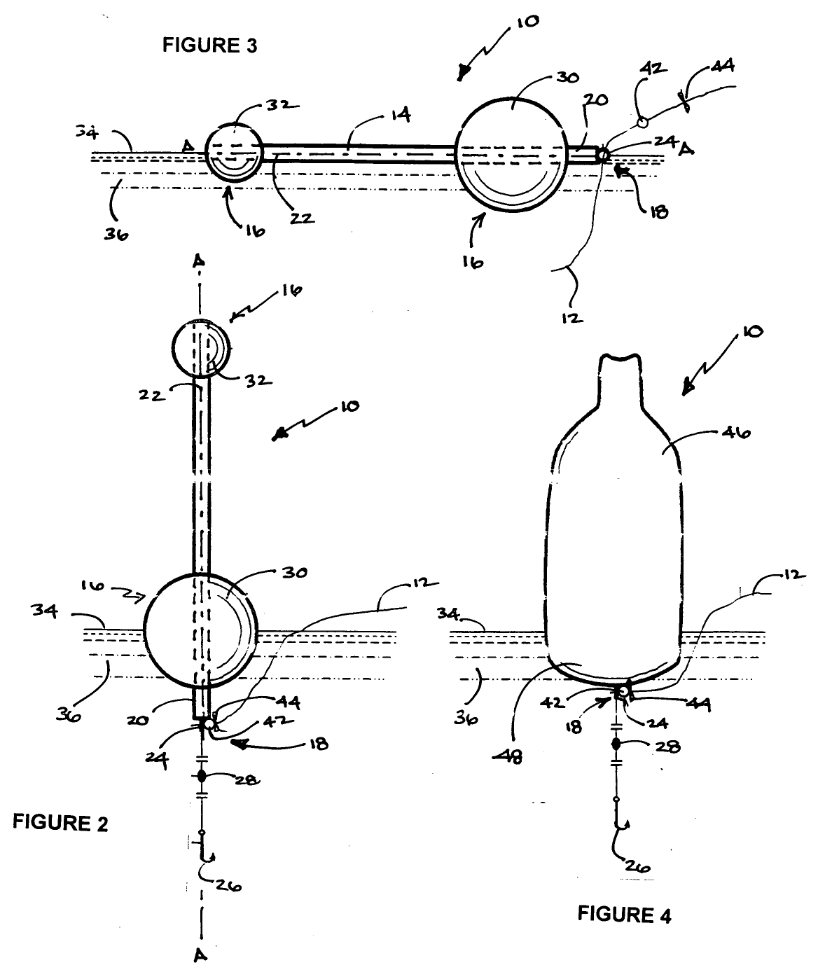

Preferably, the first and second floatation members 30 and 32 are made of a material that is sufficiently buoyant so as to enable the float 10 to remain afloat on the surface 34 of a water body 36. For example, the floatation members 30 and 32 may be made of a lightweight or hollow plastic material, cork or Styrofoam®. When using cork or Styrofoam®, a channel 38 may be provided through each of the floatation members 30 and 32 along the longitudinal axis A-A thereof, as shown in FIGS. 2 and 3. Preferably, the dimension of the channel 38 should be less than the dimension of the elongate member 14. By this design, the first and second floatation members 30 and 32 may be slidably received and frictionally retained on the first and second ends 20 and 22 of the elongate member 14, respectively. When using a hollow plastic type material, one or more apertures (not shown) may be formed in the exterior surface of the floatation members 30 and 32 to receive the elongate member 14. The dimension of the apertures on the first and second floatation members 30 and 32 and the elongate member 14 should be sized so that the first end and second end 20 and 22 of the elongate member 14 form a close, water-tight seal inside the apertures.

The dimension of the eyelet 24 of the engagement portion 18 is preferably sized to inhibit the formation of ice and the intrusion of the debris which may interfere with the movement of the fishing line 12. The eyelet 24 should be made of materials that do not corrode when exposed to water, and which are sufficiently strong to withstand repeated uses. Preferably, the eyelet 24 is made of brass or stainless steel material. It should be understood that the eyelet 24 may be formed into a permanently closed loop or may be an openable clasp-type loop which the angler may open to remove the fishing line 12.

The engagement portion 18 further includes a fishing line stop means 40 provided at a desired location along the fishing line 12. The stop means 40 may comprise a sliding bead 42 and a limiter 44. The bead 42 is disposed on the fishing line 12 between the float 10 and the fishing rod. The limiter 44 may be a knot provided in the fishing line 12 between the bead 42 and the fishing rod so as to inhibit any movement of the bead 42 towards the fishing rod end of the fishing line 12. The limiter 44 is adapted to engage with the eyelet 24 and maintain the fishing hook 26 substantially at the pre-determined depth chosen by the angler for fishing. The bead 42 is preferably dimensioned to be larger than the eyelet 24 to prevent the bead 42 from passing through the eyelet 24 when the fishing line 12 is cast into the water body 36.

The fishing float 10 of the present invention is designed to move from an engaged position to a disengaged position so as to provide an angler with a visual indication when a fish as taken or attacked the fishing line 12. In the engaged position shown in FIG. 2, the bead 42 of the stop means 40 contacts or engages with the eyelet 24 when the fishing line 12 is generally pulled taut under the weight of the sinker 28. The engaged relationship between the bead 42 and the eyelet 24 maintains the fishing line 12 at the pre-determined below the float 10. The elongate member 14 is positioned generally vertically perpendicular to the surface 34 of the water body 36 when the float 10 is disposed in the engaged position. As shown in FIG. 2, the second floatation member 32 is positioned generally vertically above the first floatation member 30 and the surface 34 of the water body 36. The eyelet 24 and bead 42 of the engagement portion 18 are generally disposed beneath the surface 34 of the water body 36 when the float 10 is in the engaged position.

In the disengaged position shown in FIG. 3, a fish has taken or attacked the fishing line 12, thereby removing the weight of the sinker 28 from the fishing line 12. The reduced tension on the fishing line 12 causes the bead 42 to become disengaged from the eyelet 24, causing the elongate member 14 to move into a generally horizontal position across the surface 34 of the water body 36. The movement of the float 10 from the engaged position to the disengaged position will indicate to the angler that a fish taken or attacked the fishing line 12, and that the angler should begin reeling in the fishing line 12. In the disengaged position, both the first and second floatation members 30 and 32 are positioned on the surface 34 of the water body 36, thereby improving the buoyancy of the float 10. As a result, the float 10 will remain visible to the angler on the surface 34 of the water body 36 in turbulent conditions or in the event that the fish attempts to dive to deeper portions of the water body 36.

The fishing float 10 of the present invention is further designed to provide the angler with a visual indication if the water body 36 is shallower than the angler's pre-determined depth for fishing. When the angler casts the fishing line 12 into the water body 36, the weight of the sinker 28 will pull on the fishing line 12 until the bead 42 become engaged with the eyelet 24, and the elongate member 14 moves into the vertical, engaged position. If the sinker 28 strikes the bottom surface of the water body 36 before the bead 42 becomes engaged with the eyelet 24, the elongate member 14 will remain in the horizontal, disengaged position. If the float 10 does not move into the engaged position after being cast into the water body 36, the angler may reel in the fishing line 12 and manually adjust the location of the bead 42 on the fishing line 12 to a location corresponding to a shallower depth. The angler may then recast the fishing line 12 into the water body 36.

Reference is made to FIG. 4 which shows an alternative embodiment of the float 10 of the present invention. In this alternative embodiment, the elongate member 14 and one or more floatation members 30 and 32 of FIG. 1 have been integrally formed into a single, bottle-shaped member 46. The eyelet 24 of the engagement portion 18 has been attached directly to the first end 48 of the single member 46. The fishing line 12 may be provided with the bead 42 of the engagement portion and threaded through the eyelet 24. The fishing line 12 may then be provided with the fishing hook 26 and sinker 28, and cast into the water body 36. In the engaged position, the bead 24 is caused to engage with the eyelet 24 as the sinker 28 pulls the fishing line 12 taut, which, in turn, causes the single member 46 to float generally vertically on the surface 34 of the water body 36. When a fishing attacks the fishing line, the bead 24 becomes disengaged from the eyelet 24 causing the single member 46 to move from the generally vertical, engaged position to the generally horizontal, disengaged position as discuss previously.

The float 10 of the present invention is designed to enable an angler to visual observe when the fishing line has been taken or attacked by a fish. In use, the angler threads the fishing line through the eyelet 24 of the engagement portion and positions the stop means 40 on the fishing line at the pre-determined depth for fishing. When fishing for particular species of fish, such as steelhead and trout, the angler may manually adjust the stop means to a location on the fishing line that corresponds to greater depth when fishing for particular deep water fish species, such as trout. Once the pre-determined depth for fishing has been selected, the angler may cast the fishing line into the water way. The weight of sinker will pull the fishing line taut until either the stop means engages with the eyelet or the fishing hook strikes the bottom surface of the water body. If the stop means engages with the eyelet, the elongate member of the float will move from a disengaged position to an engaged position. In the engaged position, the elongate member having one or more floatation members coupled thereto will be positioned generally vertically and perpendicular to the surface of the water body. The positioning of the float in the engaged position will inform the angler that the fishing line has been properly cast to the pre-determined depth.

If the elongate member of the float does not move into the engaged position after being cast, the angler will know that the pre-determine depth chosen for fishing is greater than the actual depth of the water body. The angler must then reel in the fishing line and manually adjust the position of the stop means to a location on the fishing line corresponding to a shallower fishing depth. The fishing line must then be recast into the water body, and the process repeated if the elongate member does not move into the engaged position.

Once in the engaged position, the float will remain afloat extending generally vertically from the surface of the water body on a fish takes or attacks the fishing line. When the fishing line is attacked, the downward weight of the sinker is removed by the fish, causing the stop means to become disengaged from the eyelet. The elongate member of the float will then move from the engaged position to a disengaged position. In the disengaged position, the elongate member is positioned generally horizontally across the surface of the water body, thereby providing the angler with a visual indication that a fish has taken or attacked the fishing line.

Although two specific shapes of floatation members have been shown in the drawings, it should be understood that the one or more floatation members 16 may have varying shapes or sizes so as to alter the buoyancy, sensitivity and visibility characteristics of the float. Preferably, the elongate member 14 and the one or more floatation members 16 are hollow so as to maximize the buoyancy and sensitivity of the float 10.

It should be further understood that the elongate member 14 and the one or more floatation members 16 may be coated with a luminescent material, such as fluorescent orange or yellow paint, to enable the angler to observe the float 10 from afar and under various lighting conditions.

The present invention has been described with regard to specific embodiments. However, it will obvious to persons skilled in the art that a number of variants and modifications can be made without departing from the scope and spirit of the invention.

1. A float for a fishing line, comprising:
(a) an elongate member having a first end and a second end;
(b) at least two floatation members coupled to the elongate member; and
(c) an engagement portion coupled to the first end of the elongate member, the engagement portion having an eyelet that engages with a stop means provided on the fishing line;
wherein the fishing float is positionable between an engaged position and a disengaged position, wherein the elongate member is positioned generally vertically in the engaged position, and wherein in the elongate member is positioned generally horizontally in the disengaged position.

2. A float as claimed in claim 1, wherein in the elongate member moves into the engaged position as the stop means engages with the eyelet.

3. A float as claimed in claim 1, wherein the elongate member moves into the disengaged position as the stop means disengages from the eyelet.

4. A float as claimed in claim 1, wherein the engagement portion is formed with an aperture for receiving the fishing line, and wherein the dimension of the aperture is smaller than the dimension of the stop means.

5. A float as claimed in claim 1, wherein the location of the stop means is adjustable along the fishing line, whereby the location of the stop means corresponds to a pre-determined depth.

6. A float as claimed in claim 1, wherein the stop means includes a limiter adapted to maintain the fishing hook substantially at the pre-determined fishing depth.

7. A float as claimed in claim 1, wherein the at least two floatation members include a first floatation member and a second floatation member, wherein the first floatation member is positioned generally proximate to the first end of the elongate member, and wherein the second floatation member is positioned generally proximate to the second end of the elongate member.

8. A float as claimed in claim 1, wherein the at least two flotation members are formed of a sufficiently buoyant material.

9. A float as claimed in claim 1, wherein the at least two flotation members are formed of a lightweight plastic material.

10. A float as claimed in claim 1, wherein the at least two floatation members are coated in a luminescent material.

11. A float as claimed in claim 1, wherein the elongated member is coated in a luminescent material.

12. A float for adjustably locating a fishing hook at a pre-determined depth, comprising:
(a) an elongate member having a first end and a second end;
(b) at least two floatation members coupled to the elongate member, the float members being sufficiently buoyant to maintain the fishing float afloat; and
(c) an engagement portion coupled to the first end of the elongate member, the engagement portion having an eyelet which is dimensioned to receive and engage with a stop means providing on a fishing line, whereby the location of the stop means along the fishing line corresponds to a pre-determined depth of the fishing hook.

13. A float as claimed in claim 12, wherein the elongate member is positioned generally vertically in the engaged position, and wherein in the elongate member is positioned generally horizontally in the disengaged position.

14. A float for a fishing line having a sinker, comprising:
(a) an elongate member having a first end and a second end;
(b) a first floatation member, the first floatation member being coupled to the elongate member generally proximate to the first end;
(c) a second floatation member, the second floatation member being coupled to the elongate member generally proximate to the second end; and
(d) an engagement portion coupled to the first end of the elongate member, the engagement portion including an eyelet and a stop means;
whereby the elongate member is in an engaged position when the stop means engages with the eyelet;
and whereby the elongate member is in a disengage position when the stop means becomes disengaged from the eyelet.

15. A float as claimed in claim 14, wherein the elongate member is positioned generally vertically in the engaged position, and wherein in the elongate member is positioned generally horizontally in the disengaged position.

16. A float as claimed in claim 14, wherein the second floatation member is positioned generally above the first floatation member when the elongate member is positioned in the engaged position.
